(19) United States
(12) Patent Application Publication
(10) Pub. No.: US 2010/0219951 A1
(43) Pub. Date: Sep. 2, 2010

(54) MAGNETIC FIELD BASED ALARM SYSTEM

(76) Inventor: Hector Sosa, Miami, FL (US)

Correspondence Address: SANCHELIMA & ASSOCIATES, P.A.;JESUS SANCHELIMA, ESQ., 235 S.W. LE JEUNE ROAD, MIAMI, FL, 33134, US

(21) Appl. No.: 12/396,078

(22) Filed: Mar. 2, 2009

(51) Int. Cl. G08B 13/24; G05B 23/02

(52) U.S. Cl. 340/551; 340/3.1

(57) ABSTRACT

An embodiment of the present technology provides an apparatus, comprising at least one compass sensor and at least one main electronic board capable of determining a mismatch from said compass sensor and further sending a signal to a at least one vehicle control board to activate at least one security action. The present technology also provides for a security method, comprising determining at least one variation in a magnetic field with at least one magnetic sensor, amplifying said variation by at least one electronic amplifier, processing said variation by a least one electronic board and receiving said processed variation by a vehicle control board to trigger at least one security action in an alarm system. The technology also comprises an alarm circuit, further comprising an electronic compass sensor to sample an incoming magnetic field and output a signal an electronic board to receive said signal and comprise a plurality of NOR gates, transistors, resistors, capacitors, operational amplifiers, wherein said electronic board is capable of processing said signal and a vehicle control board to receive said processed signal to trigger at least one security action in an alarm system.

### FIELD OF THE TECHNOLOGY

The disclosure relates to the art of alarm systems.

### BACKGROUND OF THE TECHNOLOGY

Car, boats, trailers, jet-skies, and snowmobiles to name a few vehicles are some of the most expensive items we own and for many people they are one of the most important pieces of property they have. We also have an increased dependency on them to get us to places. Mobile transportation theft is a major problem in the United States. Some experts report that the aforementioned vehicles are stolen every 10 seconds, while others say it's one every 15 seconds. No matter which figure is correct, it still adds up to a lot of missing cars, boats and jet skies, and a lot of unhappy owners.

In order to prevent the theft epidemic the automobile industry for example has begun to manufacture a wide variety of alarm systems. For at least 25 years, alarms have been extremely popular, and have only become more innovative as time goes on. Because not every break-in is exactly the same, the alarm industry has devised various ways to trigger them. Some of them include door, shock, window, pressure, tilt sensors. Door sensors trigger it if the door, trunk or hood is opened. Shock sensors, the alarm sounds a siren if the body of the vehicle is moved or jiggled. Window sensors, trigger an alarm if a window is broken. Pressure sensors are activated when the air pressure inside the vehicle is changed. Tilt sensors, deters thieves who do not even try to drive your motorcycle away, but instead attempt to load it up onto a tow truck and cart it away whole. When the bike or car is tilted to a certain degree, the alarm will sound. Most alarms today do not rely solely on one of the above types of sensors and state-of-the-art packages usually combine several types together to make your vehicle safer from theft.

Some of the issues that the alarms have are that the alarm systems are too sensitive, or not “smart” enough to determine what is really a theft attempt and what is a strong wind, a thunderstorm, a wandering dog, or a child on a bike riding unsteadily by. To the point that alarm systems have become ineffective because no one really pays attention to alarms anymore. When they are triggered all the time for the slightest thing, they are not really the deterrent they intended to be. Another problem with vehicle alarms is that thieves are continually coming up with new ways to work around an alarm systems, almost faster than alarm manufacturers can make systems with new features.

Nowadays, more and more automobile makers are not installing car alarm systems and moving on to car immobilizers. Better and much more than just a loud siren or flashing lights, immobilizers are an improvement because they rely on computer chips in your car key, or even a hidden switch or button in your car, these immobilizers will prevent the car from being hot-wired or started in any other manual way. The problem with these systems is that losing a key with the chip inside will deprive the owner of a couple of days of use until a new key with the coded chip is expensively replaced. But if the thief gets a hold of the key with the chip, the owner is out of luck.

There is a need in the alarm industry, to manufacture an alarm system that is smart and reliable. That knows that the thief is actually moving the vehicle away thus solving the false alarm/trigger concerns mentioned above. Moreover, in the alarm system arts, it would be desirable to progress from the computer chip in the key systems to systems that will detect that the actual vehicle is moving away. There is also further need to make these alarm systems detect the difference between movements that are caused by wind, water and animals from what is really a theft attempt.

There is also a further need in the alarm system arts to provide for an alarm system for vessels on water that is not based on proximity and is able to be mounted on any smaller vessel far way from the coast line that does not rely on a fixed hub to trigger the alarm. It further solves the issue of false alarm because of unavoidable movements of currents and wind.

### BRIEF SUMMARY OF THE TECHNOLOGY

The present technology provides an alarm system that is triggered by a change relative to the earth's magnetic field.

### BRIEF DESCRIPTION OF THE SEVERAL VIEWS OF THE DRAWINGS

The foregoing summary, as well as the following detailed description of the technology, will be better understood when read in conjunction with the appended drawings. For the purpose of illustrating the technology, there are shown in the embodiments which are presently preferred. It should be understood, however, that the technology is not limited to the precise arrangements and instrumentalities shown. In the drawings:

FIG. 1 depicts one embodiment of the technology, which comprises the alarm system in a block diagram.

FIG. 2 depicts one embodiment of the technology, where the alarm system is used in one type of vehicle namely a vessel on water.

FIG. 3 depicts one embodiment of the technology, where the alarm system is used in one type of vehicle namely a car.

FIG. 4 depicts on embodiment of the technology, where the alarm system is used in one type of vehicle namely a vessel on land.

FIG. 5 depicts one embodiment of an electronic compass sensor board and attached electronics.

FIG. 6 depicts one embodiment of a main electronic board.

FIG. 7 depicts one embodiment of a vehicle electronic control board.

FIG. 8 depicts one embodiment of a remote control board.

FIG. 9 depicts one embodiment of an electronic key pad.

FIG. 10 depicts one embodiment of the inventive method of the alarm system in a block diagram as an analog system.

FIG. 10 depicts one embodiment of the inventive method of the alarm system in a block diagram as a digital system.

### DETAILED DESCRIPTION OF THE TECHNOLOGY

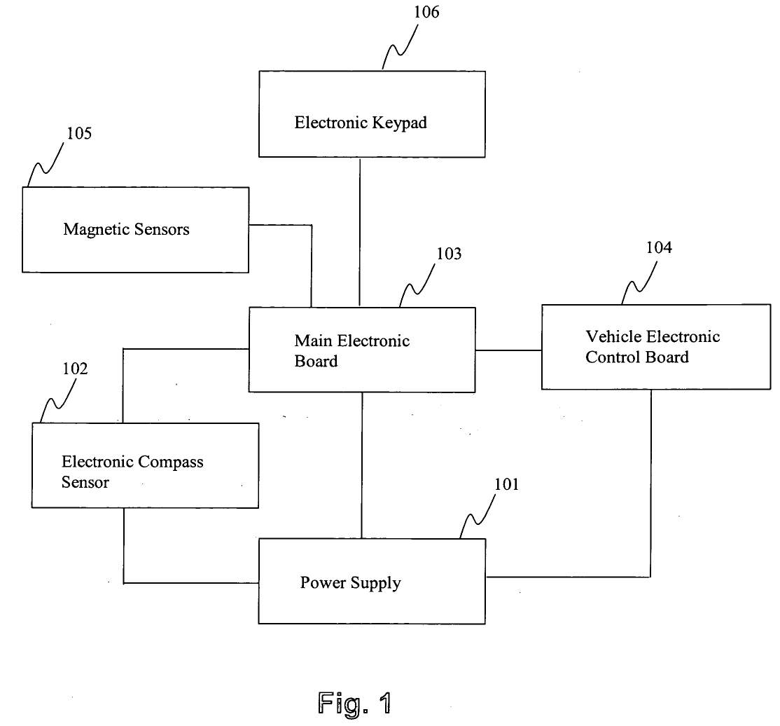

The present technology eliminates the aforementioned challenges by using at least one electronic compass sensor 102, at least one electronic keypad 106, at least one power supply 101, at least one main electronic board 103, and at least one electronic control board 104, to create a digitally based alarm system 100 as depicted in FIG. 1. The alarm system 100 is meant for land or sea vehicles which mean bicycles, cars, motorcycles, trains, ships, boats, and aircraft. The magnetic based alarm system 100 described herein uses the earth's magnetic field 204 as a reference to detect that the unauthorized horizontal angular motion caused by the thief. The alarm will trigger a signal to create security actions 901, which in turn will advise the user of the system that a theft attempt has occurred. The system comprises a magnetic field based alarm that provides for a magnetic angle that allows for some angular movement during high wind or animal movement and will only trigger the alarm when the vehicle moves to a pre-set angle therefore sensing a true theft attempt. The alarm is based on the earth's magnetic field therefore being able to be used independently anywhere and at any time.

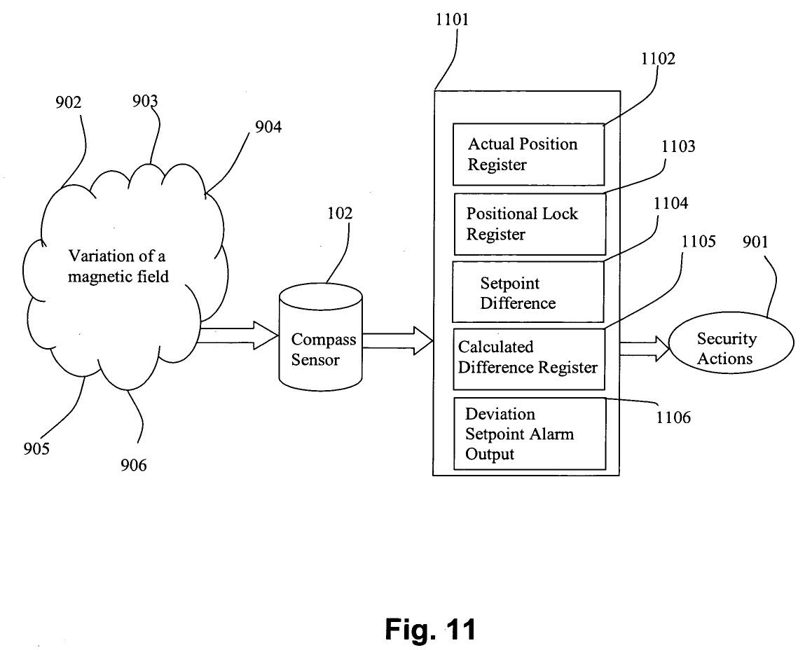

FIG. 10 depicts in more detail the inventive method and concept of the system 100. The method comprises of determining at least one mismatch between a first signal and a fixed value, and further sending a second signal to at least one vehicle control board to activate at least one security action. The first signal is sensed by at least one magnetic sensor 103, the magnetic signal may be caused by direction 902, presence 903, rotation 904, current 905 and angle 906. The first signal created by the sensor is sequentially amplified by at least one electronic amplifier 502. The signal further processed/compared by a least one electronic board 103 and finally a vehicle control board 104 receives the processed signal variation to trigger an alarm system 100. By designing the alarm system to respond to a large unauthorized motion by means of at least one electronic compass sensor 102, processed signals (voltage or current mismatch/variations) will be produced and sent to at least one main electronic board 103 and finally a series of actions 901 would take place as directed by the vehicle control board 104. Among the actions 901 that could be engaged are, an audible alarm 701, a strobe alarm light or lights, disconnection of certain functions of the vehicle, such as engine starting, fuel flow, and at the same time phone call or internet automatic calling.

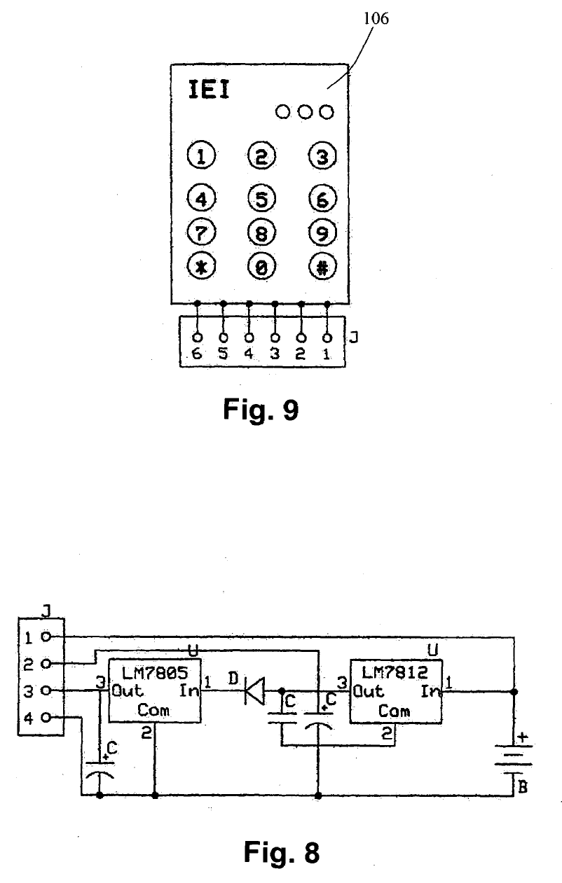

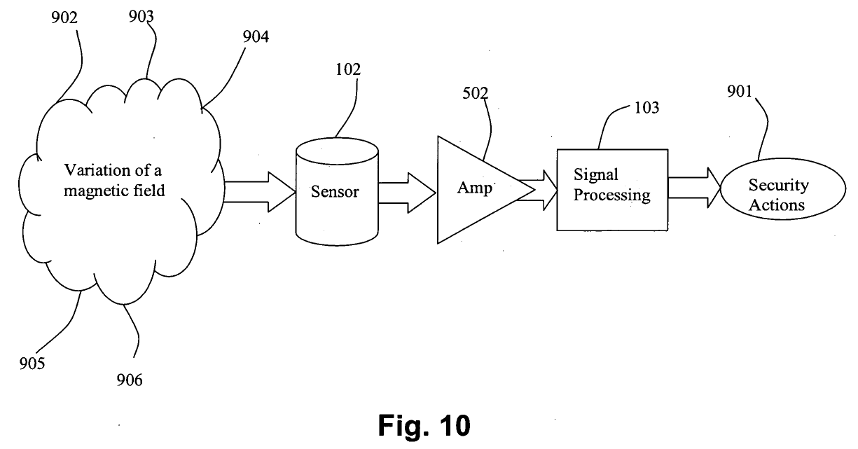

The system 100 comprises at least one compass sensor 102 which depending on its physical orientation 204 at the moment, will, obtain a voltage or current that will amount to a value particular to said orientation 206 relative to the earth's magnetic field 203. The compass sensor 102 is further connected to a power supply 101, a main electronic board 103 or processor board, and a key pad 106 or remote ON/OFF hand held switch FIG. 8. When appropriate, a back up battery will also be installed as part of the system. Upon activating the system (arming the system) using a key pad 106, the initial orientation 206 of the compass is fixed to the vehicle, for example 201, 301 or 401. Any vertical, horizontal or angular motion beyond a specified selected number of degrees will trigger the alarm circuit.

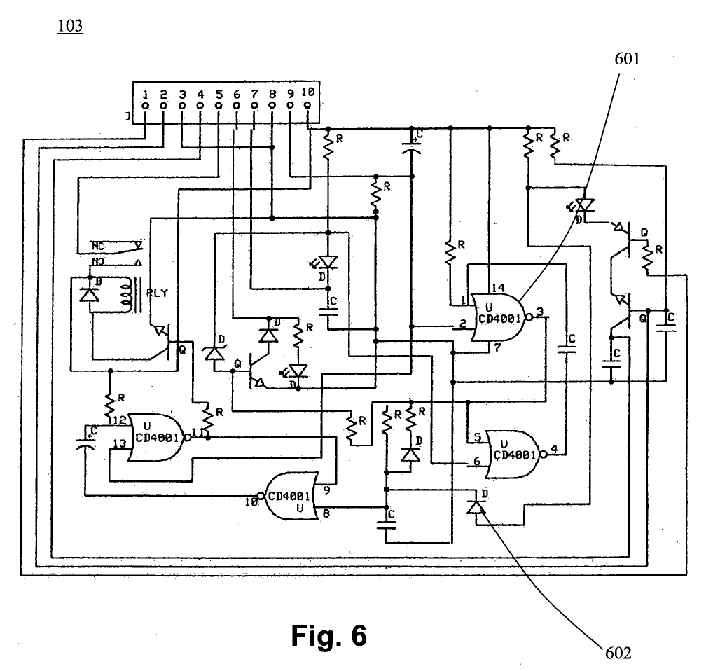

In at least one embodiment of the technology, the key pad 106 was comprised a commercially available electronic type keypad. A safety code or pass-word was selected by the owner. The key pad 106 was comprised of an independent memory system in case there was a problem with the power supply 101. The default in case of a power outage is that the system 100 will automatically adopt its initial state ARMED. The main electronic board 103 was made out of four logic “NOR” gates 601 several transistors 602, and other electrical and electronic components as depicted in FIG. 6. The circuit in said board 103 was designed to receive the voltage V_{O} coming from the electronic compass sensor 102 relative to the earth's magnetic field 203, compare it to a fixed Voltage V_{f} value established as a reference when the system was turned ON (ARMED), a mismatch voltage ΔV is produced and compared to a V_{f}. If the mismatch voltage ΔV is greater than the V_{f} fixed voltage a second signal is sent to the vehicle control board 104. This board 103 also maintains the ARMED/DISARMED condition of the alarm system.

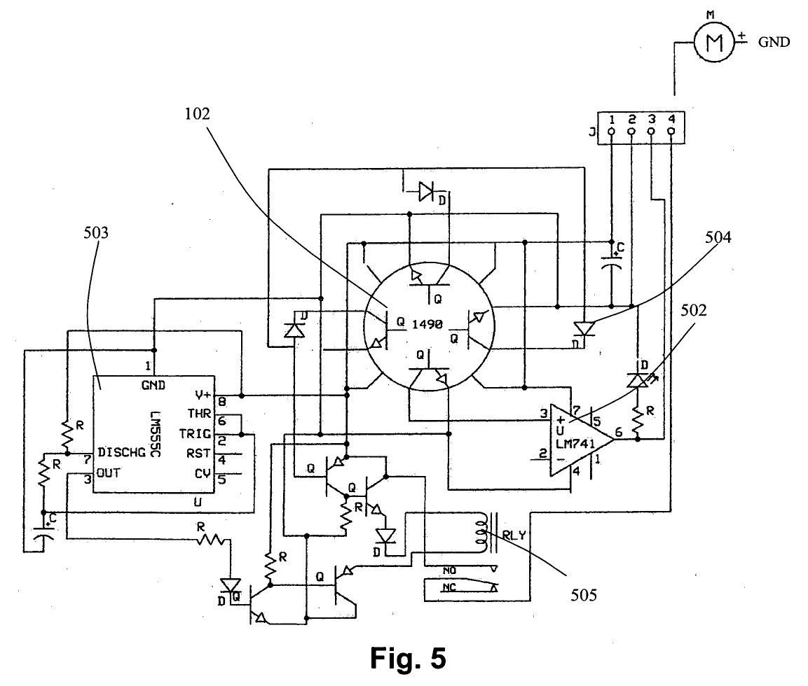

In at least one embodiment of technology, the electronic compass sensor 102 detects the magnetic orientation 206 (position) of the vehicle when it is originally placed in its resting position 204 compared to the earth's magnetic field 203 sending a particular voltage value V_{O} to the main electronic board 103 circuitry for its processing. The compass sensor 103 was connected to an operational amplifier 502, a timer chip 503 and several transistors 504, as depicted in FIG. 5, in order to produce the desired results. If the vehicle is moved a certain pre-selected number of degrees, the electronic compass sensor will send a first signal voltage to the main electronic board 103 which determines if the voltage mismatch is such as to activate the alarm. As a complement, but not deviating from the main concept of the disclosed technology, a number of magnetic contact sensors 105 on doors and windows could be installed in addition to the electronic compass sensor which would be then part of the alarm system 100. The condition of the magnetic sensors 105 would also be processed by the main electronic board 103, also to trigger the alarm.

As mentioned above, in one embodiment of the technology, several magnetic sensors 105 where connected to the main board 103. They were sensors typically used for home security systems. These protective devices monitor the opening and closure of doors and windows 105 in the vehicle. Usually, each magnetic contact features a connection for a hardwired or wireless sensor input, making it ideal for protecting multiple windows 105 using standard contacts. In at least one embodiment of the technology a Visonic MCT-302 sensor was used and placed on the vehicles doors. The wireless version was enabled with a unique ID code, and each magnetic door and window contact was available in several frequencies. Discreetly placed magnetic sensors 105 thought the vehicle prevents breaches in opening and closing of doorways and windows. By making the magnetic sensors 105 a closed circuit, if any of the sensors are opened the alarm is also triggered.

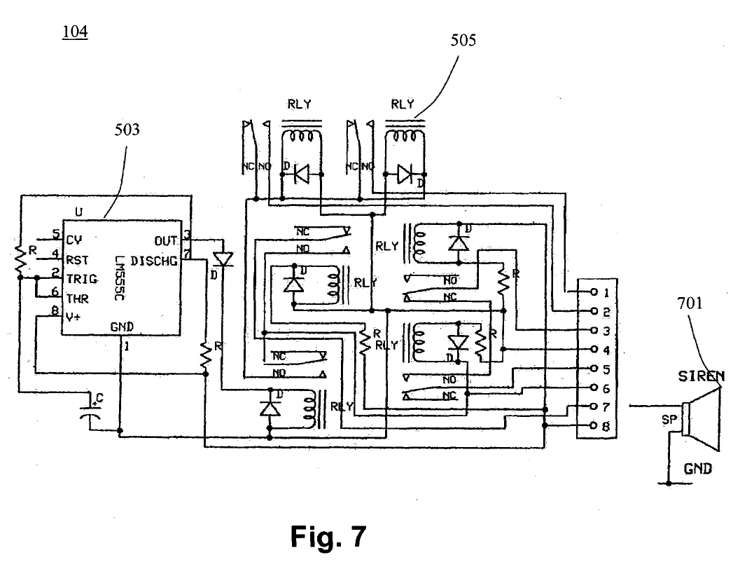

The power supply 101 was composed of the batteries of the vehicle usually 12 Volts or the system 100 also could have a separate battery. In the vehicle electronic control board 104 two voltage regulators were used, one to stabilize the voltage coming from the batteries and therefore powering the circuits which need 12 Volts. The main electronic board 103 will take 12 Volts and will convert it into 5 Volts which is needed to power the electronic compass 102. Several capacitors were used to stabilize and filter the different parasitic (noise) currents coming form other sources. The vehicle electronic control board 104 was comprised by several relays 505 and also with a timer chip 503 which will give the time for turning on and off the lights of the vehicle as well as the horn 701 as depicted in FIG. 7. This is the circuit that makes sure that the vehicle does not continue with the normal navigation course. This electronic control 104 will also cut the ignition to the engine as soon as the alarm is triggered by sensor 102. At the same time the lights will turn on and off in order to signal a theft attempt.

The key pad 106 can be composed of any commercially available keypad that allows for the owner to codify the code that engages the alarm system 100. It preferably to use a ROM based chip set that keeps into memory since data stored in ROM cannot be modified (at least not very quickly or easily). ROM refers to such types such as EPROM and flash EEPROM can be erased and re-programmed multiple times, but does not get erased of the power is turned off or cables are cut off.

In one embodiment of the technology, the main electronic board 103 comprise four logic gates 601, NOR gates. The board 103 further comprises several transistors and other components as depicted in FIG. 6. This circuit detects any signal or voltage coming from the electronic compass 102 and the magnetic sensors 105 and at the same time maintaining the alarm in the status ARMED or DISARMED i.e. ON or OFF positions. In the ARMED/ON position, the electronic board 103 will allow for a time (t) delay in the case the keypad is located inside of the vehicle and a door or window would have to be open to enter the code. If the alarm system 100 is placed in the ON position as soon as the time (t) has passed, the system 100 turns ARMED/ON, and now, as soon as the main electronic board 103 senses a mismatch in Voltage provided by any of the sensors 105 or 102 the alarm will be triggered. By the triggering of the alarm, the control board 104 will be then activated and control board 104 will disrupt the preprogrammed task or security action 901 such as demobilizing the vehicle by cutting the power or locking the power steering or cutting power to the fuel pump or turning off the engine(s). The control board will normalize and turn aforementioned circuits on as soon as the proper code is entered into keypad 106.

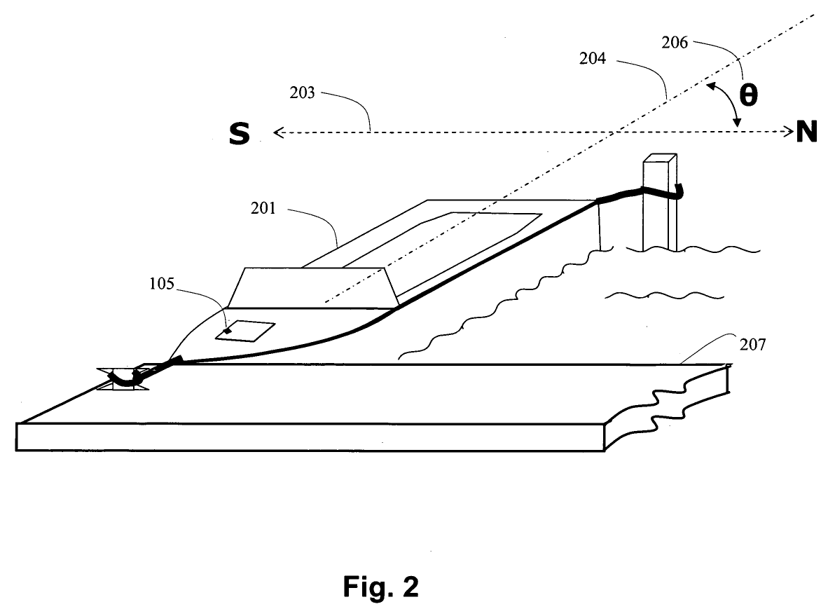

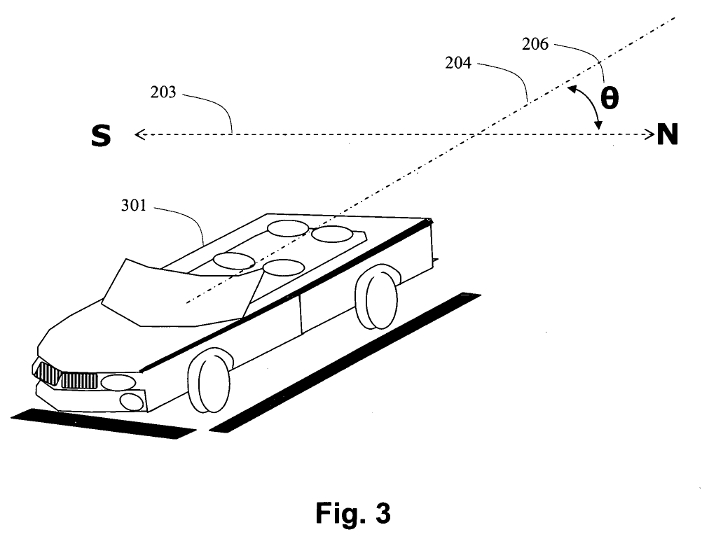

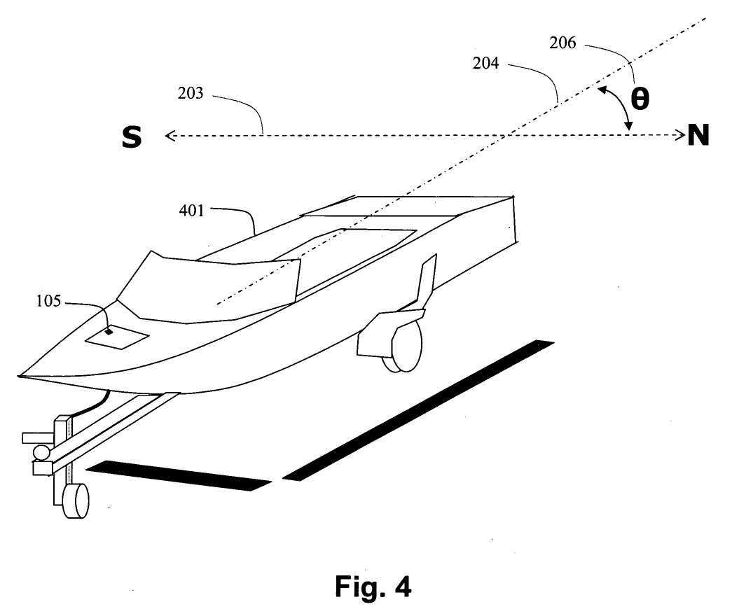

The electronic compass sensor 102, is the main sensor of the alarm system 100. After setting the alarm system 100 into the ARMED or ON position by entering the a code in key pad 106, the compass sensor 102 after a set time period (in order to allow for the exiting of the vehicle) measures or finds the magnetic position 204 that the vehicle was left alone relative to the earth's magnetic field 203. The electronic compass sensor 103 measures the voltage between the earth's magnetic field 203 and the magnetic position 204 (depicted in FIGS. 2-4 as angle θ 206 or angular position) converts it into a first signal and feeds it to the main electronic board 103. This signal is equal to a voltage created by this angular position is V_{O} which in turn is the armed voltage, which also has a preset error margin of (θ=±A) degrees in order to allow for the vehicle to move slightly, thus solving the false alarm/trigger concerns mentioned above. If the vehicle moves more than (+) plus or (−) minus a pre-set number of large degrees B or (θ=±(A+B)) compared to a fixed Voltage V_{f} (a value established as a reference in the system), a mismatch voltage ΔV is created. If the mismatch voltage ΔV is greater than V_{f} then the greater change in voltage V_{L} will be sent to the mail electronic board 103 which will trigger the alarm. By allowing some angular flexibility of (θ=±A) degrees, allows for some movement during high wind or animal movement and will only trigger the alarm when sensing a true theft attempt i.e. a large movement in the vehicle.

In one embodiment of the technology an electronic compass sensor 102 Manufactured by The Robson Company Inc., DINSMORE SENSOR was used. The model 1490 which magnetically indicates the four Cardinal (N. E, S. W) directions, and, by overlapping the four Cardinal directions, shows the four intermediate (NE, NW, SE, SW) directions. The Digital Compass Sensor 102 sends the angular information by measuring the earth's magnetic field using Hall-Effect technology. The sensor 102 is internally designed to respond to directional change similar to a liquid filled compass. It will return to the indicated direction from a 90° degree displacement in approximately 2.5 seconds with no overswing. The sensor 102 should be able operate tilted up to 12 degrees with acceptable error. It was easily interfaced to digital circuitry such as in the main electronic board 103 and microprocessors using only pull-up resistors as depicted in FIG. 5. The electronic compass sensor 102, was designed to indicate the direction of the horizontal flux pattern (Compass component) of the earth's field 203. The Sensor 102 was operated from input voltage of 5 to 20 volts DC. Input was both spike and polarity protected. The Power requirement was 1 approximately 30 mils (0.030 amps).

The sensors used for the magnetic based alarm system 100 were those typically selected from the group consisting of a range of 1 μG to 10 G which equal Earth's field sensors or Medium-Field Sensors. The magnetic range of medium-field sensors lends itself well to using the Earth's magnetic field to determine compass headings for navigation, vehicle sensing, and measure the derivative of the change in field. In this magnetic range for example, the flux-gate magnetometer, the most widely used sensor for compass-based navigation systems. The most common type, called the second harmonic device, incorporates two coils, a primary and a secondary, wrapped around a common high-permeability ferromagnetic core. Another example used for this magnetic range is the Magneto-inductive magnetometers, which is simply a single winding coil on a ferromagnetic core that changes permeability within the Earth's field. The coil is the inductance element in a L/R relaxation oscillator. The oscillator's frequency is proportional to the field being measured. A static DC current is used to bias the coil in a linear region of operation. As the sensor is rotated 90° from the applied magnetic field, the observed frequency shift can be as much as 100%.

In another embodiment of the technology, an Anisotropic Magnetoresistive (AMR) sensor was used as electronic compass sensor 102. AMR sensors are well suited to measuring both linear and angular position and displacement in the Earth's magnetic field. These devices are made of a nickel-iron thin film deposited on a silicon wafer and patterned as a resistive strip. The film's properties cause it to change resistance by 2%-3% in the presence of a magnetic field. In a typical configuration, four of these resistors are connected in a Wheatstone bridge to permit measurement of both field magnitude and direction along a single axis. The bandwidth is usually in the 1-5 MHz range. The reaction of the magneto-resistive effect is very fast and not limited by coils or oscillating frequencies. Another example of similar technology are the Giant Magnetoresistive (GMR) Devices. Large magnetic field dependent changes in resistance are possible in thin film ferromagnet/nonmagnetic metallic multilayers. Although not preferred, it would be equivalent to a person skilled in the art to manufacture a magnetic based alarm system 100 using magneto-resistive sensors such as AMR and GMR for substantially same way and purpose to obtain the same measuring result. In yet another embodiment of the technology, two Analog Sensors, Model 1525 & Model 1655 where used. The output a sine-cosine curve voltage which may be interpreted by microprocessor, graphs, or other simple system into directional information. This offers finite measurement capabilities in a directional application such as the one for a magnetic field based alarm system 100. Although analog sensors are not preferred, a person skilled in the art may also use them for substantially same purpose to obtain the same result.

In at least one of the preferred embodiments, the electronic compass sensor 102 used was made using Hall Effect semiconductor technology. The Hall Effect is a consequence of the Lorentz force in semiconductor materials. When a voltage is applied from one end of a slab of semiconductor material to the other, charge carriers begin to flow. If at the same time a magnetic field (such as the earth's 203) is applied perpendicular to the slab, the current carriers are deflected to the side by the Lorentz force. Charge builds up along the side until the resulting electrical field produces a force on the charged particle sufficient to counteract the Lorentz force. This voltage across the slab perpendicular to the applied voltage is called the Hall voltage. It is the Hall voltage that is measured by the electronic compass sensor 102 created by this angular position is V_{O} which in turn is the ARMED Voltage of the alarm system 100 sent to the main electronic board 103. Hall sensors typically use n-type silicon or GaAs for higher temperature capability due to its larger band gap. In addition, InAs, InSb, and other semiconductor materials are also used due to their high carrier mobilities that result in greater sensitivity and frequency response capabilities above the 10-20 kHz typical of Si Hall sensors.

In the alarm system, the aforementioned electronic compass sensor 102 was connected to at least one operational amplifier 502, further connected to at least one timer chip 503, and yet further connected to at least one transistor 504, several gates, resistors, and at least one relay 505. In at least one embodiment of the technology, the said electronic components were arranged as depicted in FIG. 5 in order to process and respond the signals from the compass sensor 102. The vehicle electronic control will then activate several security actions 901. The actions comprise; air horns, these are sometimes found on the inside of the vehicle and call attention to the burglar, carjack protection, which will cause the engine to turn off and a siren to blare on your vehicle, door lock/unlock, allow the power locks on the automobile to be operated by the alarm, starterkill, this will kill the ignition or starter of the vehicle when the alarm is activated so the thief can not go anywhere, flashing lights, with some alarm systems, the car headlights or parking lights will flash when the alarm is triggered, pagers, pagers that will flash or sound off to let you know when your car alarm is triggered.

In another embodiment of the technology, a digital setup was arranged as depicted in FIG. 11. The digital setup comprises at least one micro processor 1101, said microprocessor further comprising at least one actual position register 1102, at least one positional lock register 1101, at least one setpoint difference 1104, at least one calculated difference register 1105, and a deviation setpoint alarm output 1106 component. A HONEYWELL Digital Compass HMC6532 102 was connected to the Microprocessor 1101 thought a 12C serial protocol cable. The microprocessor 1101 will receive the signals from the Digital Compass Sensor 102, which read the angular 206 direction in relation to the earth's magnetic field 203 and monitor as actual position register 1102. The microprocessor 1101 will fix the position at the time of heading lock or when the user activates the alarm system in the positional lock register 1103. This value will be then will be compared as to a set point difference 1104 and calculated and stored in the calculated difference register 1105, to this calculated difference register a deviation setpoint 1106 will be added. The micro processor will continuously read values form the digital compass 102 and compare them to the deviation value by way of binary subtraction. Once a difference value 1104 is reached an output on the microprocessor will be sent and security actions 901 will be activated.

The inventive technology described in FIG. 10 and FIG. 11 may also be attached to a Vehicle Tracking System; thus, if the vehicle is stolen or lost, the system manufacturer can track its whereabouts by satellite and find it quickly, usually within hours. Further attachments are for example, the active re-arm feature which is when the alarm has been disarmed, the alarm will automatically re-arm after a certain amount of time if a door is never opened. This prevents accidental disarms. The system 100 will automatically arm itself after the vehicle is turned off and the doors are all closed. The owners never have to remember about whether or not you armed the alarm. The technology disclosed herein is specially suited for vessels on water. The technology is not based on proximity and is able to be mounted on any smaller vessel far way from the coast line that does not rely on a fixed hub or dock 207 to trigger the alarm. By giving the system some angular flexibility, it further solves the issue of false alarm because of unavoidable movements of currents and wind while the vessel is docked 207.

It will be appreciated by those skilled in the art that changes could be made to the embodiments described above without departing from the broad inventive concept thereof. It is understood, therefore, that this technology is not limited to the particular embodiments disclosed, but it is intended to cover modifications within the spirit and scope of the present technology.

What is claimed is:

1. An apparatus to avoid theft, comprising:
at least one compass sensor; and
at least one main electronic board capable of receiving a first signal from said compass sensor, determining a mismatch between the first signal and a fixed value, and further sending a second signal to at least one vehicle control board to activate at least one security action.

2. The apparatus of claim 1, wherein said mismatch is determined by at least one microprocessor.

3. The apparatus of claim 1, wherein said compass sensor works in the range of 1 μG to 10 G. as Earth's field sensor and Medium-Field sensor.

4. The apparatus of claim 1, wherein said compass sensor is selected from the group consisting of flux-gate magnetometers, magneto-inductive magnetometers, anisotropic magneto-resistive sensors, giant magneto-resistive devices, analog sensors, and Hall Effect sensors.

5. The apparatus of claim 1, wherein said compass sensor is able to detect a magnetic field change selected from the group consisting of, direction, presence, rotation and angle.

6. The apparatus of claim 1, further comprising at least one key pad and at least one power supply.

7. The apparatus of claim 1, wherein said vehicle control board's security actions are selected from group consisting of, turn on/off lights, turn doors on/off, turn windows on/off, cut power on/off, turn on a siren, turn on horn, turn off engine, turn off fuel pump, locking power steering, calling a pager, calling a phone number and sending a signal to the internet.

8. The apparatus of claim 1, wherein said main electronic board is capable of determining a mismatch from magnetic sensors placed in doors and windows.

9. The apparatus of claim 1, wherein said mismatch is created by a change in voltage.

10. The apparatus of claim 1, wherein said mismatch is created by a change in current.

11. The apparatus of claim 1, wherein said mismatch is amplified by at least one operational amplifier.

12. The apparatus of claim 1, wherein said apparatus is used as an alarm system for vehicles on land and on water.

13. A security method, comprising:
determining at least one variation in a magnetic field with at least one magnetic sensor;
amplifying said variation by at least one electronic amplifier;
processing said variation by a least one electronic board; and
receiving said processed variation by a vehicle control board to trigger at least one security action in an alarm system.

14. The method of claim 12, wherein said variation further creates a change in voltage.

15. The method of claim 12, wherein said variation further creates a change in current.

16. The method of claim 12, wherein said magnetic variation is comprised of a change selected form the group consisting of, direction, presence, rotation and angle.

17. The method of claim 12, wherein said vehicle control board's security actions are selected from group consisting of, turn on/off lights, turn doors on/off, turn windows on/off, cut power on/off, turn on a siren, turn horn on, turn off engine, turn if fuel pump, locking power steering, calling a pager, calling a phone number and sending a signal to the internet.

18. The method of claim 12, wherein said variation is amplified by at least one operational amplifier.

19. The method of claim 12, wherein said compass sensor is selected from the group consisting of flux-gate magnetometers, magneto-inductive magnetometers, anisotropic magneto-resistive sensor, giant magneto-resistive devices, analog sensors, and Hall Effect sensors.

20. The method of claim 12, wherein said method is used as an alarm system for vehicles on land and on water.

21. An alarm circuit, comprising:
an electronic compass sensor to sample an incoming magnetic field and output a signal;
an electronic board to receive said signal and comprise a plurality of NOR gates, transistors, resistors, capacitors, operational amplifiers, wherein said electronic board is capable of processing said signal; and
a vehicle control board to receive said processed signal to trigger at least one security action in an alarm system.

22. The circuit of claim 20, wherein said compass sensor is selected from the group consisting of flux-gate magnetometers, magneto-inductive magnetometers, anisotropic magneto-resistive sensor, giant magneto-resistive devices, analog sensors, and Hall Effect sensors.

23. The circuit of claim 20, wherein said compass sensor works in the range of 1 μG to 10 G. as Earth's field sensor and Medium-Field Sensor.
